(19) United States
(12) Patent Application Publication
(10) Pub. No.: US 2016/0020530 A1
(43) Pub. Date: Jan. 21, 2016

(54) Device for Contacting a Bus Bar

(71) Applicant: Multi-Holding AG, Allschwil (CH)

(72) Inventor: Anton Bürge, Ormalingen (CH)

(21) Appl. No.: 14/768,031

(22) PCT Filed: Feb. 14, 2014
(86) PCT No.: PCT/EP2014/052920

§ 371 Date: Aug. 14, 2015

(30) Foreign Application Priority Data
Feb. 15, 2013 (EP) 13155412.3

(51) Int. Cl. H01R 4/24

(52) U.S. Cl. CPC H01R 4/2416

(57) ABSTRACT

The invention relates to a contact device (1) for contacting a bus bar (2) having at least two contact surfaces (3, 4) extending parallel to each other and at a distance from each other, comprising a clamping unit (5) for applying a clamping force to the first of said contact surfaces (4) and a contact unit (6) for electrically contacting a second of said contact surfaces (3), wherein the clamping unit (5) lies at a distance from the contact unit (6), such that there is an intermediate space (7) between the clamping unit (5) and the contact unit (6), which intermediate space is used to accommodate said bus bar (2). The clamping unit (5) comprises a clamping element (8) that acts on said contact surface (4), in particular a lever (8), which can be moved onto the contact surface (4) in relation to the intermediate space (7). The contact unit (6) comprises a contact jaw (9) having a surface (10) facing the intermediate space (7), at least one contact element (11) that can be moved in relation to the surface (10) and that protrudes into the intermediate space (7), and a connection element (12) connected to the contact element (11) in an electrically conductive manner.

### TECHNICAL FIELD

The present invention relates to a contact device for contacting a bus bar according to the preamble of claim 1.

### PRIOR ART

Devices for contacting bus bars are known from the prior art.

By way of example, U.S. Pat. No. 7,806,711 presents a device of this type. The device comprises lever elements, which are acted on with a spring force via a spring. The lever elements are secured to a bus bar and serve to contact this bus bar with another bus bar. In so doing, this other bus bar is slid into the intermediate space between two lever elements.

A disadvantage of the contacting according to U.S. Pat. No. 7,806,711 is that if the two bus bars are tilted relative to one another it is not possible to create defined contact.

### DISCLOSURE OF THE INVENTION

Proceeding from this prior art the object of the invention is to specify a contact device for contacting a bus bar, which contact device overcomes the disadvantages of the prior art. In particular, the contacting of bus bars of different width and/or the compensation of an angular tolerance is/are to be improved.

This object is achieved by the subject matter according to claim 1. Accordingly, a contact device serves to contact a bus bar having at least two contact faces extending parallel to one another and at a distance from one another. The contact device comprises a clamping unit for applying a clamping force to the first of said contact faces and a contact unit for electrically contacting a second of said contact faces. The clamping unit lies at a distance from the contact unit, such that an intermediate space is provided between the clamping unit and the contact unit, which intermediate space serves to accommodate said bus bar. The clamping unit comprises a clamping element acting on said contact face, in particular a lever. The clamping element can be moved onto the contact face in relation to the intermediate space. The contact unit comprises a contact jaw having a surface facing toward the intermediate space, at least one contact element protruding from the surface into the intermediate space, and a terminal element electrically conductively connected to the contact element. The contact element is preferably displaceable or movable in relation to the surface.

It is thus possible with the clamping element to reduce the intermediate space between contact unit and clamping unit, wherein the contact device is drawn against the bus bar. Angular errors and/or irregularities in the bus bar can be compensated for by the at least one displaceable contact element, such that good electrical contact is always enabled.

The contact element is electrically conductively connected via a contact face to the contact face of the bus bar. The contact face can be formed in a variety of ways. By way of example, the contact face may be formed as a flat or planar face extending parallel to said surface. The contact face may also comprise at least one cutting element. The cutting element is preferably a cutting edge or a conical tip. The at least one cutting element here extends preferably from the planar face. The contact face may also be provided exclusively by the at least one cutting element.

The cutting element has the advantage that, for example, bus bars that are coated with an electrically insulating shrink tube, a layer of paint, an oxide layer or that are coated otherwise with an electrically insulating material can also be contacted with the contact device.

A plurality of contact elements are particularly preferably arranged at regular distances from one another.

The terminal element is connected in a particularly preferred embodiment to a cable. This is implemented in particular via a terminal unit.

The contact element preferably has the form of a pin. The pin is mounted movably in a bore in the contact jaw and comprises a contact face for electrically contacting the bus bar. The contact face may be the end face of the pin and at least one cutting element arranged on the end face. Alternatively, the contact face may also be provided exclusively by the at least one cutting element, wherein this then closes the pin with respect to the intermediate space.

The pin is preferably acted on in said bore with a spring, wherein the spring presses the pin in the direction of the surface as considered from the bore. The spring force acts in the direction of the intermediate space. In the event of contact with the bus bar, the pin can be moved into the bore against the spring force.

The clamping unit and the contact unit are preferably displaceable relative to one another along a movement axis, such that the distance or the width of the intermediate space between clamping unit and contact units can be adjusted substantially to the width of the bus bar.

As a result of the relative displaceability between clamping unit and contact unit, the intermediate space can be adjusted roughly to the width of the bus bar. The fine adjustment, which leads ultimately to the contact, is achieved by the clamping element and the contact element as described above. Bus bars of different widths can be contacted particularly easily and quickly as a result of this adjustability.

The contact unit and the clamping unit are preferably contacted with one another via guide elements. These guide elements allow a relative movement between contact unit and clamping unit along a movement axis and prevent a relative movement about the movement axis. The contact unit and clamping unit can thus be moved toward one another and away from one another along a linear movement. In other words: the guide elements allow an axial displacement of the contact unit in relation to the clamping unit whilst simultaneously preventing a radial movement between the two components.

The guide elements preferably have the form of at least one guide pin, which protrudes into an opening of the contact unit and an opening of the clamping unit. The guide pin is preferably pressed into one of the openings and is securely held there.

The contact device preferably has an elongate connection element extending along the movement axis, via which the contact unit and the clamping unit are connected to one another.

The connection element preferably has the form of a bar, in particular with a circular cross section. Alternatively, the connection element preferably has the form of a pipe.

The clamping unit, particularly preferably in the end region of the connection element, is preferably connected to the connection element fixedly in relation to a movement along the movement axis, and the contact unit is mounted movably on the outer circumferential face of the connection element. Said adjustment of the intermediate space can be achieved by the displaceability of the contact unit.

The connection element is preferably mounted rotatably about the movement axis relative to the stationary clamping unit and relative to the stationary contact unit. Consequently, the connection element can rotate about the movement axis relative to the two units.

In a preferred embodiment the connection element is connected to the clamping unit via a bearing point, wherein the connection element is mounted fixedly relative to the clamping unit in relation to a movement along said movement axis, and wherein the connection element is mounted rotatably relative to the clamping unit in relation to a movement about the movement axis.

Said bearing point on the clamping unit particularly preferably has a locking element arranged at an angle to the connection element and a groove arranged on the connection element and running around the movement axis, wherein the locking element engages with the groove. The locking element is preferably fork-shaped, such that it can engage with the groove on two sides.

In said preferred embodiment the contact unit, in particular the contact jaw, has a continuous opening, wherein the connection element is guided through this opening. The connection element is pivotable relative to the contact unit about the movement axis and is movable along the movement axis.

The opening in the contact unit particularly preferably has an inner thread, and the connection element has an outer thread cooperating with the inner thread, wherein, when the connection element is rotated relative to the stationary contact unit, the contact unit is moved along the movement axis. The distance of the movement per revolution is dependent here on the pitch of the thread.

The arrangement of the thread has the advantage that the clear width of the intermediate space can be adjusted by rotating the connection element. The user can thus adjust the distance of the contact unit in relation to the clamping unit by rotating the connection element.

In a development of the invention the connection element is part of the terminal element, wherein the connection element is electrically contacted with the contact elements of the contact unit via an electrically conductive connection.

Consequently, the contact elements thus act on the bus bar, and the connection element is electrically conductively connected to the bus bar via the contact elements.

In a particularly preferred embodiment the least one contact element is electrically conductively connected to the contact jaw, and the contact jaw is electrically conductively connected to the connection element. Consequently, an electrically conductive connection is thus established between the contact element and connection element via the contact jaw.

A conveying element, preferably a multi-lamella contact, is preferably provided between the at least one contact element and the contact jaw and/or between the contact jaw and the connection element.

The terminal element preferably has a terminal receptacle, which is electrically conductively connected to the connection element or the terminal element and which has a terminal portion for receiving a cable. The terminal receptacle is preferably arranged opposite the clamping unit. The terminal element and terminal receptacle form a terminal unit.

The connection element preferably extends at least in part into an opening in the terminal receptacle, wherein a conveying element, in particular a multi-lamella contact, is arranged in the opening and conveys electrical contact between the terminal receptacle and connection element, and wherein the connection element is mounted rotatably in the opening.

The terminal receptacle consequently remains still in the event of a rotation of the connection element relative to the clamping unit and the contact unit.

The clamping element can preferably be actuated with an actuator element, wherein the actuator element is preferably a rod mounted by the connection element, which rod acts on the lever via a front end. The actuator element is particularly preferably mounted within the tubular connection element.

The connection element particularly preferably has an inner thread for receiving a set screw, wherein the set screw acts on the actuator element, in particular on the rear end of the rod, and moves the actuator element in the connection element in the event of a rotation of the set screw.

The lever particularly preferably has a return element in the form of a spring, which holds the lever in a rest position.

The contact device preferably also has a housing, which is electrically insulating.

The housing preferably comprises a first housing part, which extends around the contact jaw, and a second housing part, which extends around the connection element and is connected thereto for conjoint rotation therewith, wherein the housing parts overlap one another in portions. During the adjustment movement between clamping unit and contact unit, the user can apply the movement to the connection element via the second housing part.

In an alternative embodiment the terminal element has the form of a pipe, in which an actuator element is longitudinally displaceable along the center axis of the pipe and is mounted non-rotatably relative to the pipe, which actuator element acts via its front end on the clamping element, in particular on the clamping jaw, whereby this is displaceable relative to the contact unit. In this embodiment the contact device comprises the clamping unit, the contact unit and the terminal element, to which at least the contact unit, preferably also the clamping unit, is/are electrically conductively connected.

In said alternative embodiment a terminal unit is particularly preferably arranged at the end of the pipe opposite the clamping element and contact element. Here, the terminal unit is formed such that it can be electrically conductively connected to an external element. The terminal element, which is electrically conductively connected to the contact unit, can be connected to the external element via the terminal unit.

The terminal unit has a terminal receptacle with an opening. The terminal element, in particular the pipe, extends at least in part into an opening in the terminal receptacle, wherein a conveying element, in particular a multi-lamella contact, is arranged in the opening and conveys electrical contact between the terminal receptacle and the terminal element, in particular the pipe, and wherein the terminal element, in particular the pipe, is mounted rotatably or fixedly in the opening.

Further embodiments are specified in the dependent claims.

### BRIEF DESCRIPTION OF THE DRAWINGS

Preferred embodiments of the invention will be described hereinafter with reference to the drawings, which serve merely for explanation and are not to be interpreted as limiting. In the drawings:

FIG. 1 shows a perspective view of a contact device having a clamping unit and a contact unit in accordance with a first embodiment of the present invention;

FIG. 2 shows a sectional view through the contact device according to FIG. 1;

FIG. 3 shows a sectional view through the contact device according to FIG. 1, wherein the contact unit is shown in another position;

FIG. 4 shows a detail of FIG. 2;

FIG. 5 shows a detail of FIG. 2;

FIG. 6 shows a sectional view through the contact unit according to FIG. 1;

FIG. 7 shows a detail of the clamping unit and contact unit according to FIG. 1;

FIGS. 8a/b show a perspective and partially sectional view of a contact device having a clamping unit and a contact unit in accordance with a second embodiment of the present invention;

FIG. 9 shows a sectional view through the contact device according to FIG. 8;

FIG. 10 shows a sectional view through the contact device according to FIG. 8, wherein the contact unit is shown in another position;

FIG. 11 shows a detail of FIG. 9;

FIG. 12 shows a detail of FIG. 9;

FIGS. 13a/b show a perspective view of a contact device having a clamping unit and a contact unit in accordance with a third embodiment of the present invention;

FIG. 14 shows a sectional view through the contact device according to FIG. 13;

FIG. 15 shows a sectional view through the contact device according to FIG. 13, wherein the contact unit is shown in another position;

FIG. 16 shows a detail of FIG. 15;

FIG. 17 shows a detail of FIG. 15; and

FIG. 18 shows a perspective detail of FIG. 13 with a contact element in accordance with a second variant.

### DESCRIPTION OF PREFERRED EMBODIMENTS

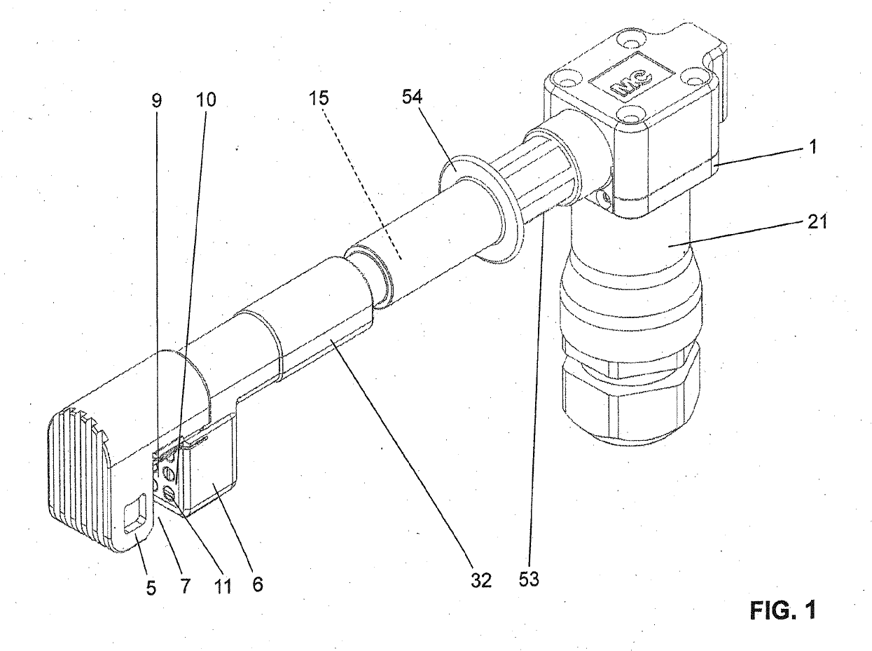

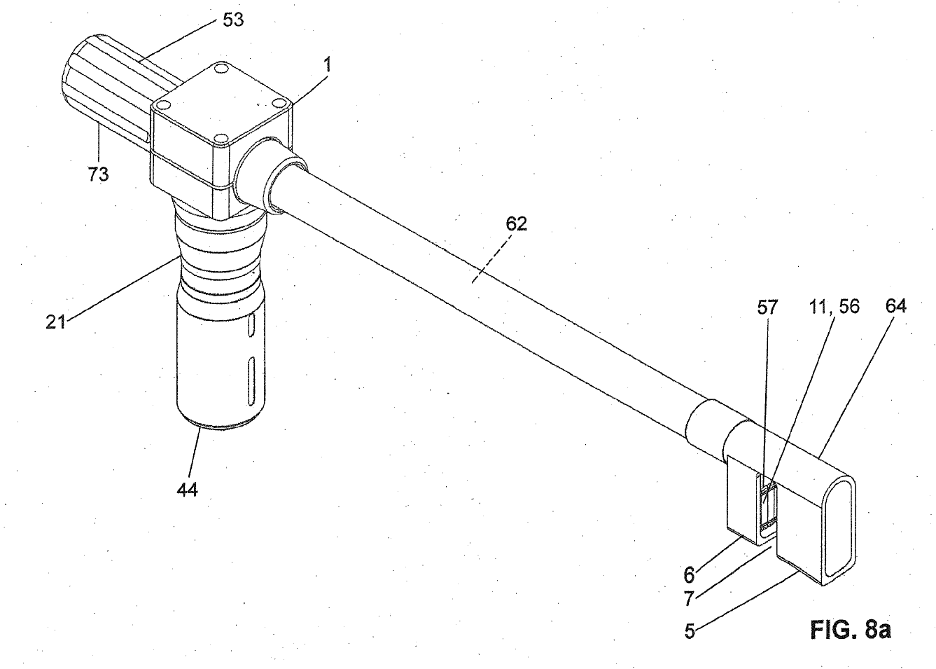

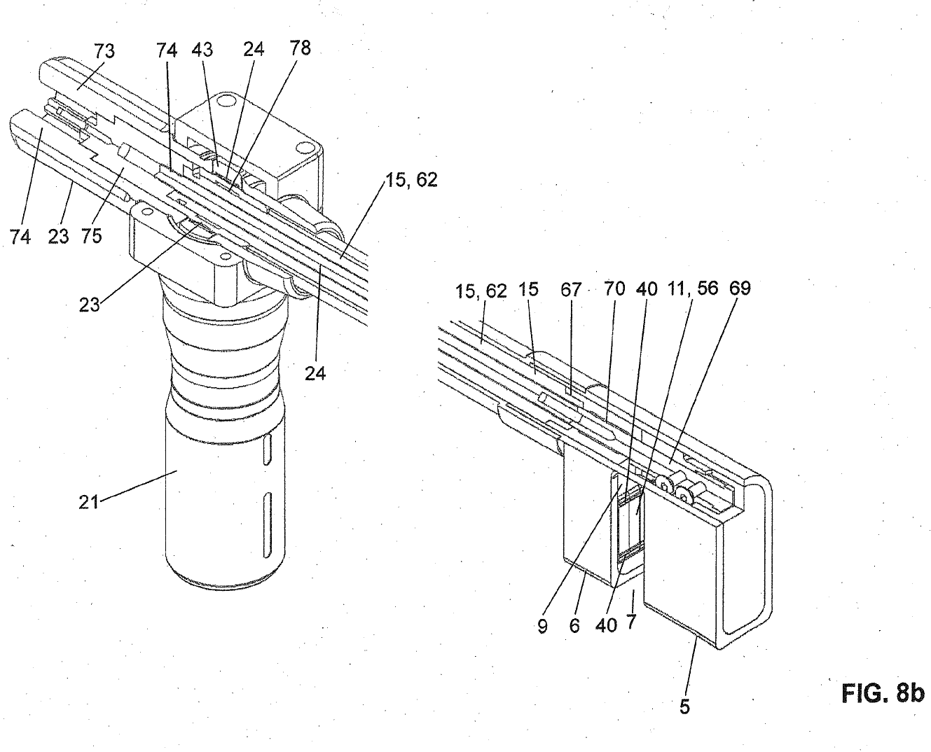

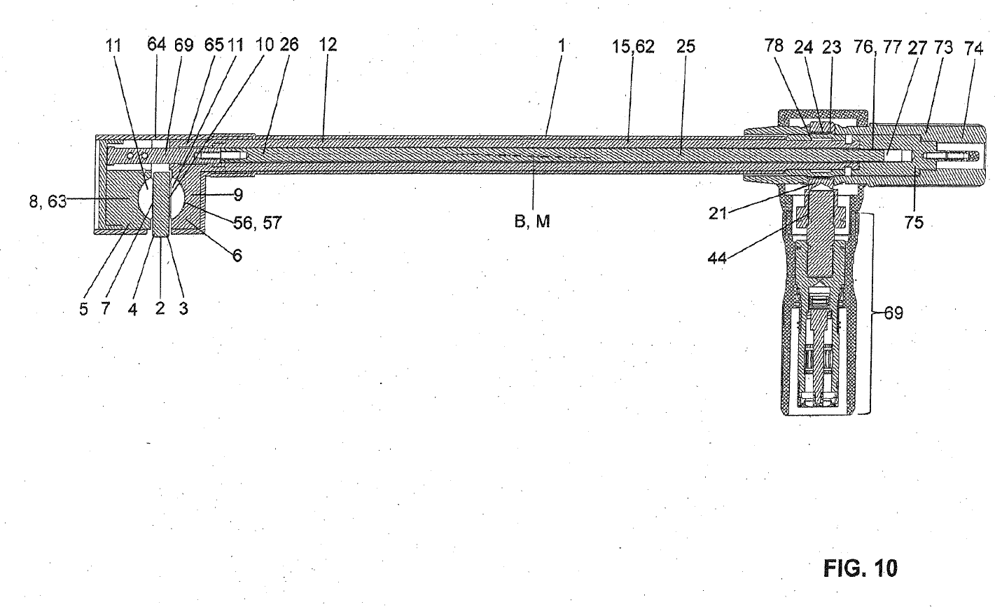

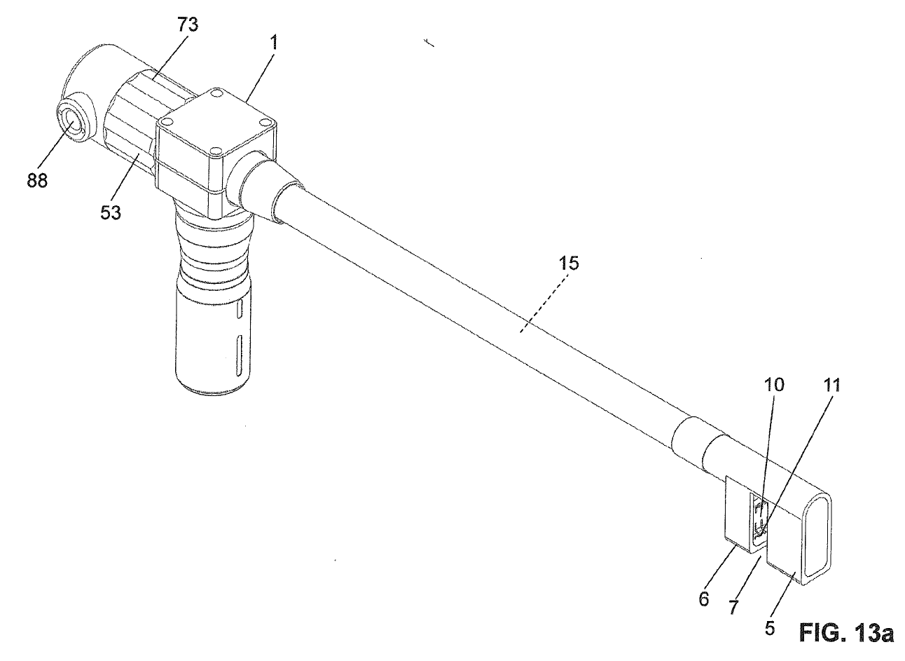

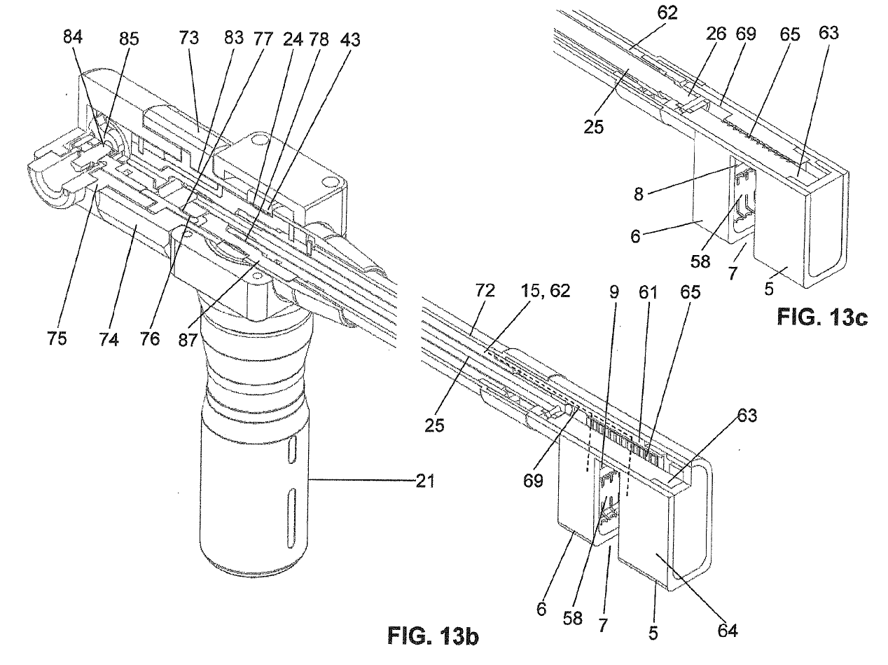

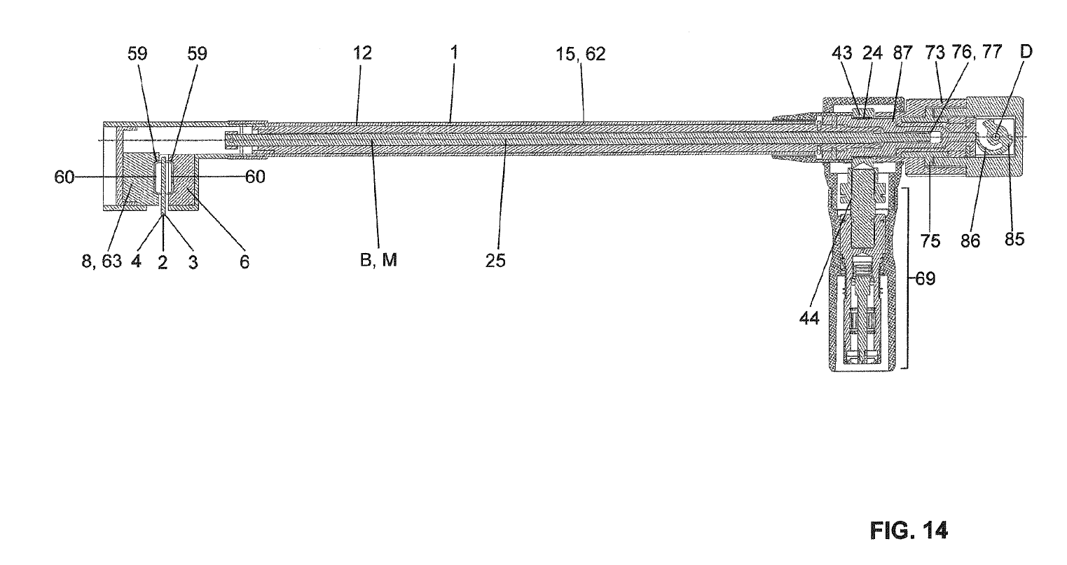

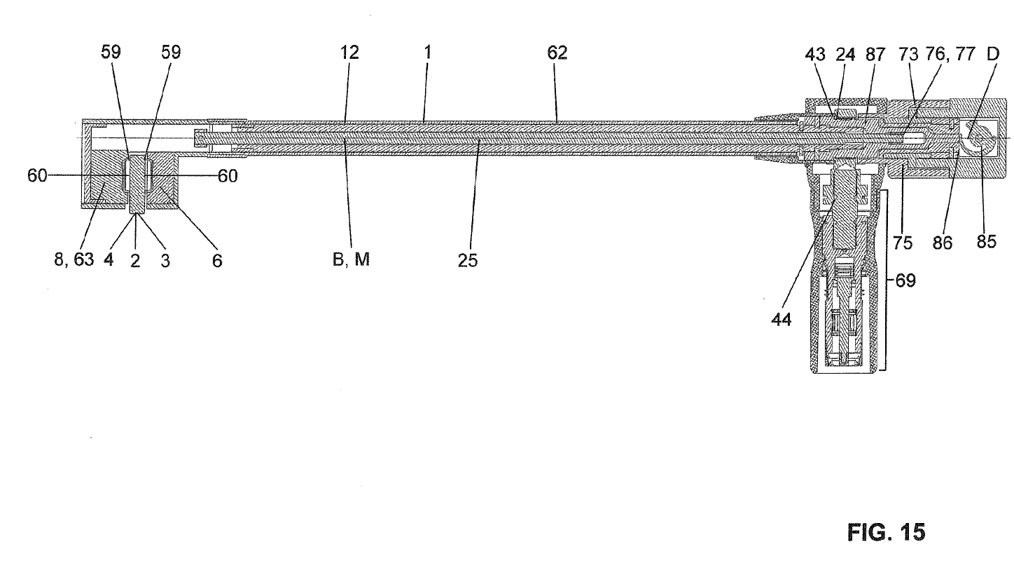

A first embodiment of the present invention is shown in FIGS. 1 to 7. FIGS. 8a to 12 show a second embodiment of the present invention. Lastly, FIGS. 13a to 18 show a third embodiment of the present invention. Like parts carry like reference signs.

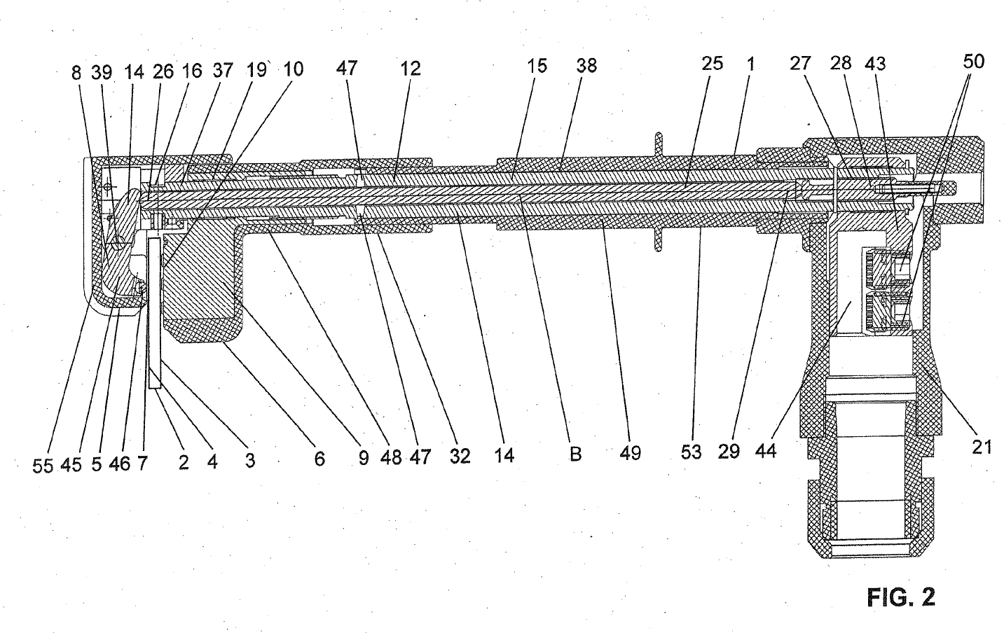

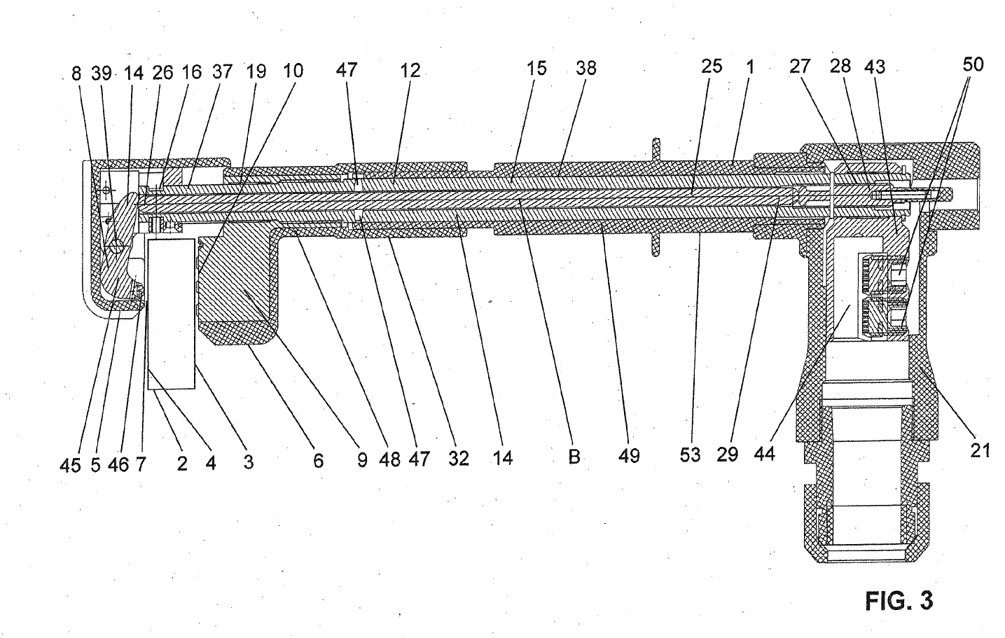

FIG. 1 shows a contact device 1 in accordance with a first embodiment for contacting a bus bar 2. The bus bar 2 is illustrated schematically in FIGS. 2 and 3. The contact device 1 serves for the attachment to the bus bar of a cable connected to the contact device 1, which cable is not illustrated in FIG. 1. Electrical contact is to be provided between the bus bar and the cable.

The contact device 1 comprises a clamping unit 5 for applying a clamping force to the bus bar and a contact unit 6 for electrically contacting the bus bar. The contact device 1 according to FIG. 1 also comprises a terminal unit 21. The terminal unit 21 serves for the connection of a cable to the contact device 1.

The clamping unit 5 is arranged at a distance from the contact unit 6. An intermediate space 7 is provided between the clamping unit 5 and the contact unit 6 and serves to receive said bus bar.

The clamping unit 5 and the contact unit 6 are movable relative to one another. FIGS. 2 and 3 show the contact device 1 in a sectional illustration. The intermediate space 7 between the clamping unit 5 and the contact unit 6 is smaller in the position shown in FIG. 2 than in the position shown in FIG. 3. A thinner bus bar 2 can thus be clamped in FIG. 2. The structure of the contact device 1 will now be explained in greater detail with reference to FIGS. 2 and 3.

The clamping unit 5 fundamentally applies a clamping force to the contact face 4 of the bus bar 2, whereas the contact unit 6 electrically contacts the bus bar 2 via the second contact face 3.

The clamping unit 5 comprises a clamping element 8 acting on said contact face 4. Here, the clamping element 8 has the form of a lever 8. The lever 8 can be moved onto the contact face 4 of the bus bar 2 in relation to the intermediate space 7. In the present embodiment the lever 8 can pivot about a pivot axis 39. The lever 8 and operating principle thereof will be described in greater detail further below.

The contact unit 6 comprises a contact jaw 9 with a surface 10 facing toward the intermediate space 7. The contact unit 6 also comprises at least one contact element 11, which is displaceable in relation to the surface 10 and protrudes into the intermediate space 7, and a terminal element 12 electrically conductively connected to the contact element. A plurality of contact elements 11 are arranged in the present embodiment. The terminal element 12 provides an electrical connection between the terminal unit 21 and the contact elements 11. The voltage across the bus bar 2 can thus be tapped via the contact elements 11 and the terminal element 12 and where applicable the terminal unit 21. However, the terminal element 12 can also be electrically conductively connected directly to an external element, wherein the terminal unit could then be omitted.

In the contacted state the lever 8 applies a constant force to the contact face 4 of the bus bar 2. The contact jaw 9 with the contact elements 11 is drawn against the contact face 3 via this force, such that constant electrical contact is provided between the contact face 3 and the at least one contact element 11. It should be noted at this juncture that the bus bar preferably has a rectangular cross section, wherein the two contact faces 3, 4 are faces extending parallel to one another.

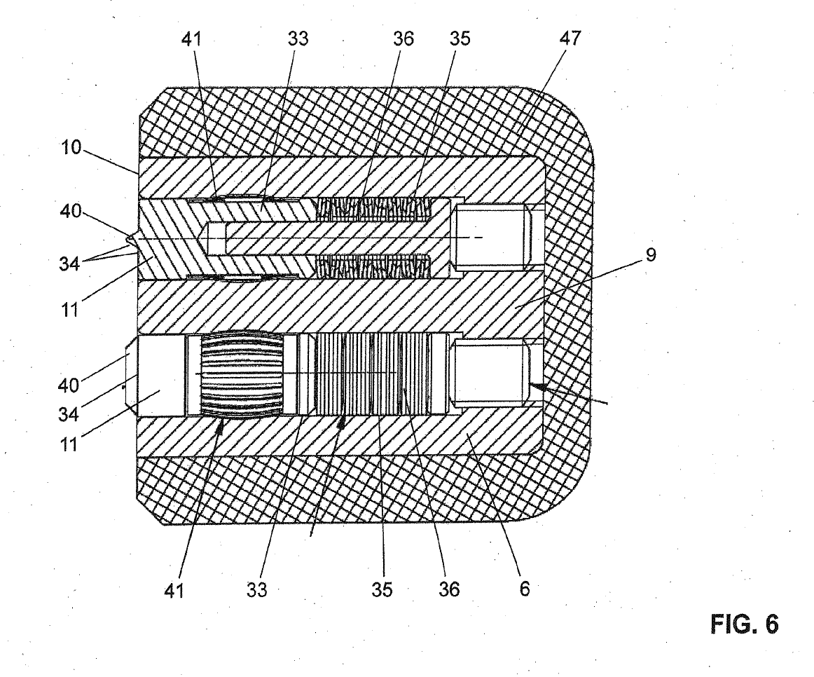

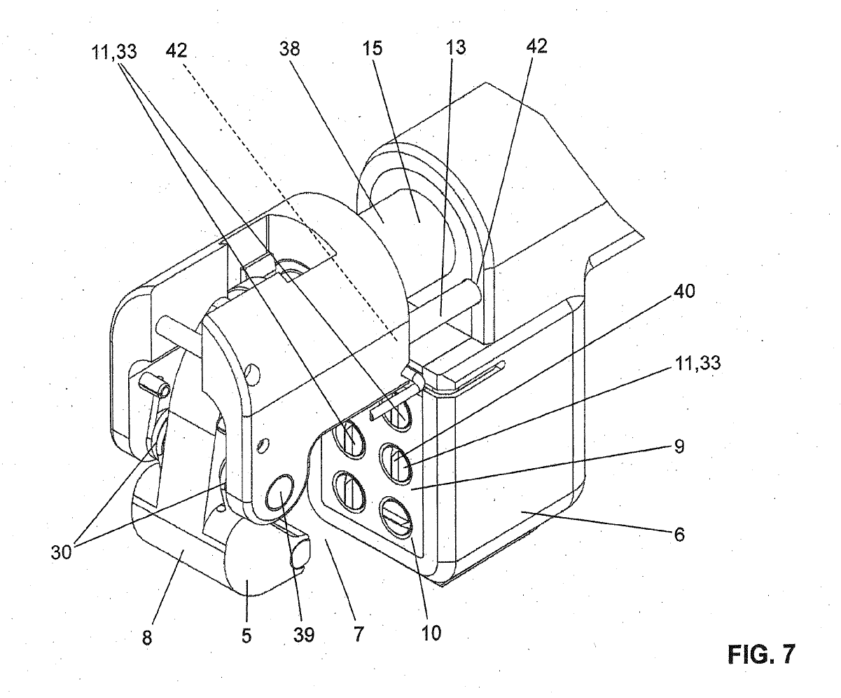

The contact element 11, as shown in FIGS. 6 and 7, has the form of a pin 33. The pin 33 is preferably a cylindrical pin. The contact jaw 9 has a bore 35 per contact element 11 or pin 33, in which bore the pin 33 is mounted movably. The bores 35 extend from the surface 10 into the contact jaw 9. The pin 33 has a contact face 34, which electrically contacts the bus bar 2. The contact face can be formed in a variety of ways. Here, the contact face 34 has the form of a cutting edge 40, which can also be referred to as a cutting element. The cutting edge 40 extends from the end face of the pin 33. The end face may also be part of the contact face depending on the design of the cutting edge 40. The pin 33 is acted on by a spring 36, which presses the pin 33 in the direction of the surface 10 as considered from the bore 35. If the pin 33 is now pressed into the bore 35, the spring provides a corresponding spring force against the movement of the pressing-in of the pin. The spring 36 for example may be a disk spring or a compression spring. The arrangement of the spring and of the pin in a particularly preferred embodiment is shown in FIG. 6.

The contact element 11 or the pin 33 also comprises at least one cutting element 40. A cutting edge 40 is shown in the figures. The cutting element extends substantially from the end face of the pin 33 in the direction of the intermediate space 7. The cutting element forms the contact face 34, or part of the contact face 34. By way of example, a bus bar provided with a shrink tube can be contacted by the cutting element, wherein the cutting element penetrates the shrink tube and comes into electrical contact with the bus bar. The cutting element may also be formed differently, however, for example as a conical tip.

In FIG. 6 it is also shown that a conveying element 41 for improving the electrical contact between pin 33 and the surface of the bore 35 is provided between the pin 33 and the bore 35. Here, the conveying element 41 is a multi-lamella contact, which provides the electrical contact between the pin 33 and the contact jaw 9.

The movability between the clamping unit 5 and the contact unit 6 will now be explained in greater detail with reference to FIGS. 2, 3 and 4. The clamping unit 5 and the contact unit 6 are displaceable relative to one another along a movement axis B, such that the width of the intermediate space 7 between clamping unit 5 and contact unit 6 can be adjusted. In the present embodiment the contact unit 6 can be displaced accordingly relative to the stationary clamping unit 5.

The clamping unit 5 is connected to the contact unit 6 via a guide element 13. The guide element 13 is shown in FIG. 7 as a guide pin 13. Here, only one guide pin 13 is shown, however two or more guide pins 13 may be provided. The guide pins 13 here guide the relative movement between the contact unit 6 and clamping unit 5. The guide elements 13 extend parallel to the movement axis B and prevent a movement of the two units 5, 6 relative to one another about the movement axis. Consequently, it is not possible for the clamping unit 5 to pivot relative to the contact unit 6.

Here, the guide element 13 protrudes into openings 42 in the clamping unit 5 and in the contact unit 6. The guide element 13 is preferably pressed into one of the two openings 42 and moves into the other opening 42 during the adjustment of the intermediate space 7.

The contact device 1 also comprises a connection element 15 extending along the movement axis B. The connection element 15 connects the contact unit 5 to the clamping unit 6, wherein the contact unit 5 and clamping unit 6 are connected to one another via the connection element 15. The connection element 15 preferably has the form of a bar or a pipe 15, as is shown in the figures.

The clamping unit 5 is arranged here in the end region 37 of the connection element 15. The clamping unit 5 is connected to the connection element 15 in such a way that the clamping unit 5 is connected to the connection element 15 fixedly in relation to a movement along the movement axis B. The contact unit 6 is mounted movably on the outer circumferential face 38 of the connection element 15. This means that the contact unit 6 is movable in relation to the clamping unit 5 connected fixedly to the connection element 15.

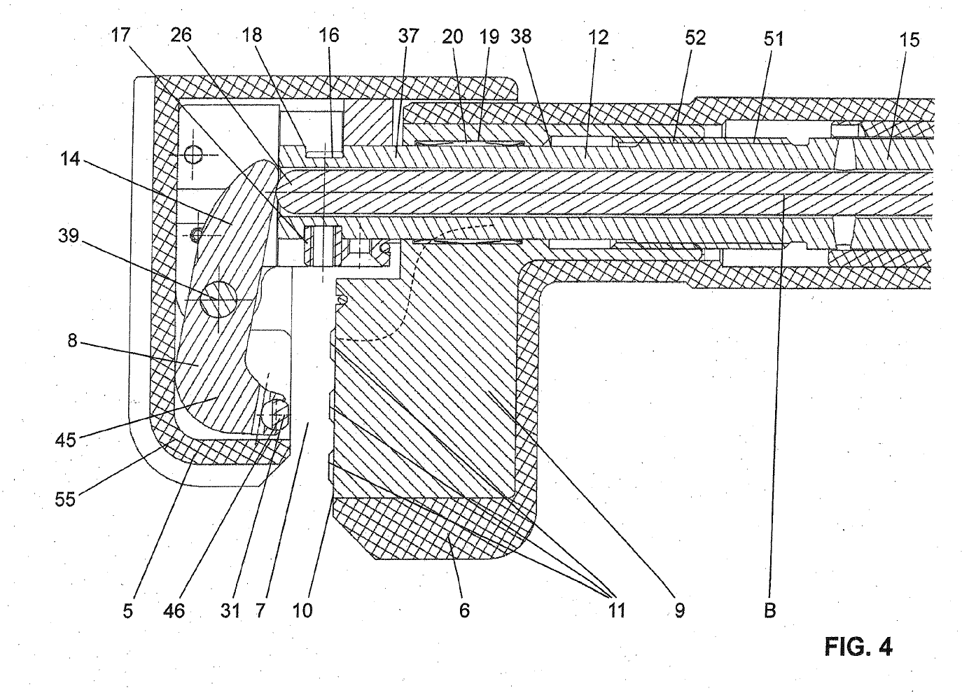

The connection element 15 is rotatable however about the movement axis B relative to the clamping unit 15 and relative to the contact unit 6. The connection element 15 can consequently rotate both relative to the clamping unit 5 and relative to the contact unit 6. This functionality will now be explained in greater detail with reference to FIG. 4.

The connection element 15 is connected to the clamping unit 5 via a bearing point 16. Here, the bearing point 16 is formed in such a way that a movement between the clamping unit 5 and connection element 15 along the movement axis B is not possible. However, the connection element 15 can rotate about the movement axis B. The bearing point 16 basically comprises a locking element 17 mounted in the clamping unit 5, which locking element engages with a groove 18. The groove 18 extends into the connection element 15 from the outer circumferential face 38 of the connection element 15.

The contact unit 6, here the contact jaw 9, has a continuous opening 19, through which the connection element 15 is guided. In other words, it can be said that the contact unit 6 is mounted on the connection element via the opening 19. Here, the connection element 15 can be pivoted relative to the contact unit 6 about the movement axis B. The contact unit 6 or the contact jaw 9 can also move along the movement axis B over the outer circumferential face 38. The connection element 15 can move relative to the contact unit 6 in the axial and also radial direction.

The opening 19 has an inner thread 52 and the connection element 15 has an outer thread 51 matching the inner thread 52 at the corresponding point. The outer thread 51 is engaged here with the inner thread 52. If the connection element 15 now rotates about the movement axis B, this results in an adjustment of the intermediate space 7, because, due to the engagement of the two threads 51, 52, the rotary movement on the connection element 15 results in a longitudinal movement of the contact unit 6. The intermediate space 7 can thus be adjusted by rotation of the connection element 15. The guide element 13 does not result in a pivoting between clamping unit 5 and contact unit 6.

The connection element 15 is also part of the terminal element 12, which connects the contact unit 6 to the terminal unit 21. The connection element 15 is electrically contacted here with the contact elements 11 of the contact unit 6 via an electrically conductive connection. As already explained above, the at least one contact element 11 is electrically conductively connected here to the contact jaw 9. The contact jaw 9 is then in turn electrically conductively connected to the connection element 15, wherein a conveying element 20, such as a multi-lamella contact, is provided preferably between the connection element 15 and the opening 19 in the contact jaw. The path of the electrical connection from the upper contact element 11 to the connection element 15 is illustrated in a dashed manner in FIG. 4. The dashed line, however, is to be understood to be purely schematic.

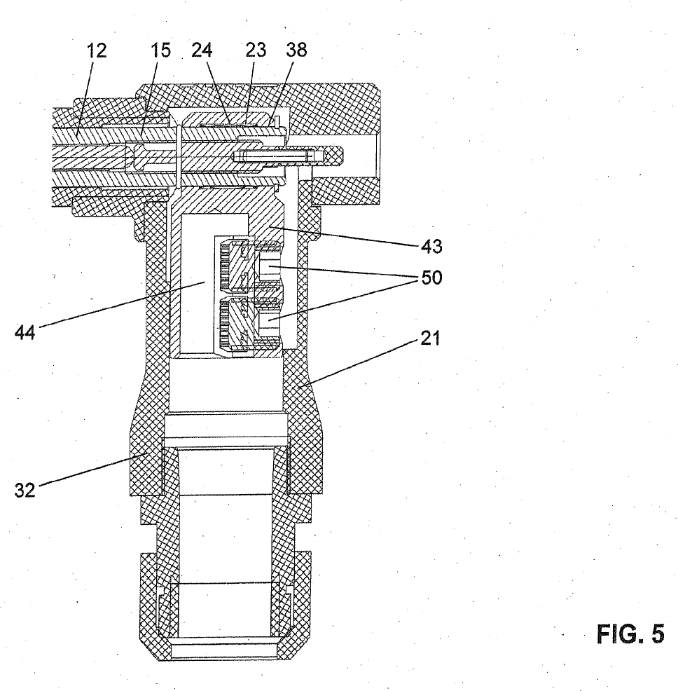

The contacting of the terminal unit 21 will now be explained in greater detail with reference to FIG. 5. The terminal unit 21 has a terminal receptacle 43. This terminal receptacle 43 has an opening 23, which is electrically conductively connected to the connection element 15 via a conveying element 24, in particular a multi-lamella contact. The connection element 15 is in turn arranged rotatably relative to the terminal receptacle 43. The terminal receptacle 43 also comprises a contact opening 44, via which a cable can be attached. The cable can be clamped in the contact opening 44, for example via screws 50. In another design the cable can be attached via a press-fit connection or via a conical clamping point in the form of an inner cone and/or outer cone.

With reference to FIG. 2, the entire electrical contact of the contact device 1 from the contact elements 11 to the terminal receptacle can now be summarized. The contact elements 11 are electrically connected via the contact jaw 9 and the connection element 15 to the terminal receptacle 43, wherein a conveying element is provided between each of said parts in order to improve the electrical contact.

With reference to FIGS. 2 and 3, the actuation of the clamping element 8 will now also be explained. The clamping element 8 can be actuated using an actuator element 25. In the present embodiment the actuator element 25 has the form of a rod 25, which is mounted within the connection element 15 in the form of the pipe 15. The actuator element 25 can move along the movement axis B. The actuator element 25 acts on the lever via a front end 26. Here, the lever has an upper lever portion 14 and a lower lever portion 45. The front end 26 acts on the upper lever portion 14 and presses the lower lever portion 44 against the bus bar 2. Here, the lever is pivoted accordingly via the pivot axis 39. In the lower lever portion 45 the lever additionally has a bearing element 46.

The connection element 15 in the region of the terminal unit 21 has an inner thread 27 for receiving a set screw 28. The set screw 28 acts here on the actuator element 25, in particular on the rear end 29 of the rod 25. In the event of a rotation of the set screw 28, the actuator element 25 in the connection element 15 is moved along the actuation axis B. With regard to FIG. 2 it can be said that when the actuator element 25 is slid against the lever portion 44, the clamping process is performed. As soon as the set screw is moved again in the other direction, the actuator element 25 also moves in the same direction. The lever 8 is for this purpose preloaded accordingly by a spring element. The return spring 30 is shown accordingly in FIG. 7.

It can also be seen from the sectional illustration in FIG. 2 that the contact device 1 comprises a housing 32. The housing 32 extends substantially completely around the contact device 1. Merely the surface 10 and the contact pins 11 or 33 are accessible from the outside. All other elements are electrically insulated by the housing 32. In the rear region, specifically in the region of the terminal unit 21, the housing 32 has a grip portion 53. The connection element 15 can be rotated by hand via this grip portion 53. Consequently, the housing 32 is connected fixedly to the connection element 15. For this purpose the connection element 15 has corresponding connection points 47. In other words, it can also be said that the housing 32 basically comprises a first housing part 48 and a second housing part 49. The first housing part 48 extends here around the contact jaw 9, and the second housing part 49 extends around the connection element 15. The first housing part 48 here has a slightly greater diameter than the housing part 49, such that the housing part 49 can protrude into the housing part 48. The housing part 49, as already explained, is connected accordingly to the connection element 15. In the region of the grip the housing also has a protective shield 54, which provides a stop for the hand of the user so that this does not come into contact with the bus bar. The clamping unit 5 is formed here also with a third housing part 55, which electrically insulates the clamping unit 5. The three housing parts 48, 49 and 55 are formed separately from one another.

A contact device 1 for contacting a bus bar in accordance with a second embodiment is shown in FIGS. 8a to 12. Like parts carry like reference signs compared with the previous figures. The second embodiment differs from the first embodiment fundamentally by the design of the clamping unit 5, in particular of the clamping element 8, and by the design of the contact unit 6, in particular of the contact element 11, and by the design of the parts responsible for the movement between clamping unit 5 and the contact unit 6.

The contact element 11 could also be used, however, in the other embodiments.

The contact device 1 according to the second embodiment comprises a clamping unit 5 for applying a clamping force to the first of said contact faces 4 and a contact unit 6 for electrically contacting a second of said contact faces 3.

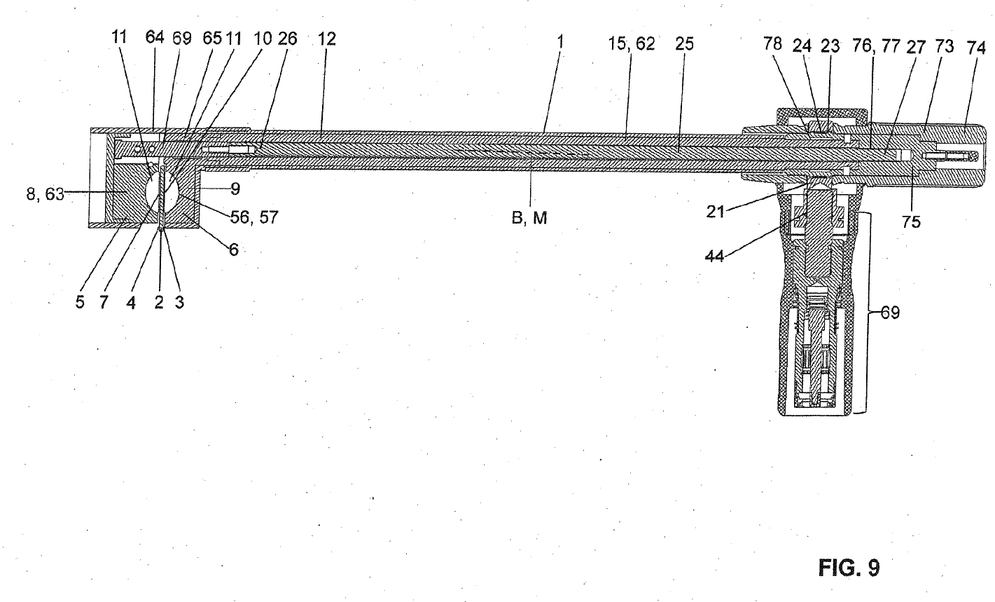

The sectional illustration according to FIGS. 9, 10 and 11 shows that the contact element 11 has the form of at least one rocker 56, which is mounted in a rocker mount 57 in the contact jaw 9. The rocker 56 comprises said contact face 34 for electrically contacting the bus bar 2. The rocker 56 has a bearing portion 66 opposite the contact face 34, which bearing portion is concavely rounded and lies in the convexly rounded rocker mount 57. As a result of the rounded design, it is made possible for the rocker 56 to incline slightly in the rocker mount, such that an optimal adjustment of the rocker relative to the contact face 3, 4 of the bus bar is achieved. The rocker 56 particularly preferably comprises at least one of said cutting elements 40 on the contact face 34.

The rocker 56 is electrically conductively connected to the rocker mount 57 and thus also to the contact jaw 9.

The contact jaw 9 itself is electrically conductively connected to a terminal element 12 in the second embodiment. The terminal element 12 is a pipe 62, as will be discussed further below. The pipe 62 protrudes into a receiving opening 67 on the contact jaw 9 and is preferably connected to the contact jaw 9 in an integrally bonded manner. The voltage can be transferred from the bus bar to a further element via the terminal element 12. Here, the voltage is transferred to a terminal unit 21, which in turn can be connected to a cable. Here, the terminal unit 21 is electrically conductively connected to the pipe 62.

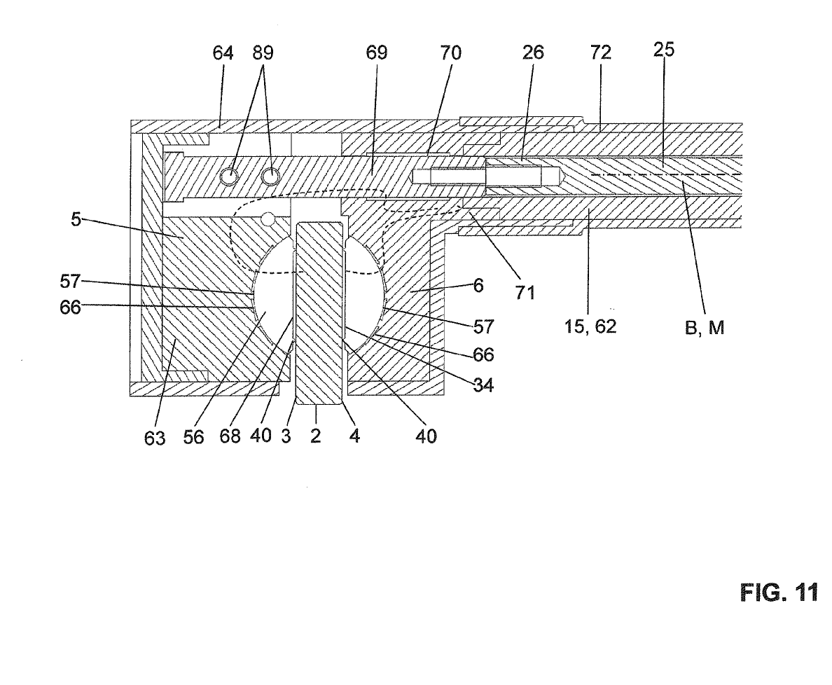

In FIG. 11 the path of the electrical connection from the rocker 56 to the terminal element 12 is illustrated in a dashed manner. The dashed line is to be understood, however, to be purely schematic.

The clamping element 8 in the second embodiment is a clamping jaw 63. The clamping jaw 63 is shown clearly in FIG. 11. The clamping jaw 63 has a contact face 68 for contacting the bus bar 2. In a variant the contact face may be an integral part of the clamping jaw 63 and is provided in particular by a surface thereof. In a further variant the contact face 68 may be part of a rocker 56, which is mounted in a rocker mount 57 in the clamping jaw 63. The rocker 56 and the rocker mount 57 can be mounted here in the clamping jaw 7 in a manner analogous to the mounting in the contact jaw 9.

It can be clearly seen from the partially sectional illustration in FIG. 8b and from the detail of FIG. 11 that in the second embodiment not only is electrical contact between the contact jaw 9 and the pipe 62 provided, but also electrical contact between the pipe and the clamping jaw 63. The clamping jaw 63 is electrically conductively connected to a connection part 69. The connection part 69 protrudes for its part into the pipe 62 or is electrically conductively contacted therewith. A conveying element 70 for providing the electrical contact between the connection part 69 and pipe 62 is arranged in a gap between the connection part 69 and the contact jaw 9. The connection part 69 can be slid in the pipe 62 and optionally also in the contact jaw 9 along the center axis M. Generally speaking, the clamping element 8 is electrically conductively connected to the contact jaw 9 and said terminal element 12, here in the form of the pipe 62.

In the second embodiment the terminal element 12 is a pipe 62, in which an actuator element 25 is mounted longitudinally displaceably along the center axis M of the pipe 62 and non-rotatably relative to the pipe 62. The actuator element 25 acts via its front end 26 on the clamping element 8, in particular acts on the clamping jaw 63, whereby this is displaceable relative to the contact unit 6. The actuator element 25 acts here via the connection part 69 on the clamping jaw 63. For this purpose the actuator element 25 is connected via a threaded connection to the connection part 69, wherein the connection part 69 protrudes into the pipe 62, such that the above-described electrical contact between pipe 62 and connection part 69 can be provided. The connection part 69 is fixedly connected to the clamping jaw 63, for example via a screw connection 89.

In other words, the actuator element 25 is fixedly connected to the clamping element 8, in particular to the clamping jaw 63, via the connection part 69.

In the shown embodiment the pipe 62 is extended by a bore 71 in the contact jaw 9. The pipe 62 is electrically conductively connected to the contact jaw in this bore 71. In another variant, however, the connection part 69 may also protrude into the pipe 62.

The pipe 62 is surrounded externally by an electrically insulating housing 72.

The clamping element 8 is displaceable relative to the pipe 62 along the center axis M of the pipe 62. The clamping element 8 is preferably mounted movably in a housing 64. The housing 64 is preferably connected fixedly to the contact jaw 9 and the housing 72, which surrounds the pipe 62 externally.

At least one guide element is provided between the clamping element 8 and the pipe 62 or other elements, which guide element prevents a rotation between the clamping element 8 and the pipe 62. However, the guide element may also be provided by a tongue and groove connection or by flat guide regions.

A drive element 73 is arranged opposite the clamping unit 5 and the contact unit 6. The contact device thus also comprises a drive element 73, which is arranged at the opposite end of the pipe 62. The drive element 73 externally has a grip portion 53. The drive element 73 is connected to the actuator element 25 via a thread 74. In the event of a rotation of the drive element 73, the actuator element 25 is slid along the center axis of the pipe 62 on account of the cooperation via the thread and the non-rotatable mounting in said pipe 62. Here, the drive element 73 comprises a grip part 74 and a sleeve element 75 located non-rotatably in the grip part 74, which sleeve element has an inner thread 76, which is in contact with the outer thread 77 of the actuator element 25.

The sleeve part 75 is also electrically conductively contacted with the pipe 62. For this purpose a conveying element 78 is located between the pipe and sleeve part. The sleeve part externally is electrically contacted via a conveying element 24 with the terminal unit 21, more specifically with an opening 23 provided in the terminal receptacle 43. A conveying element 24 producing the electrical contact is preferably arranged between the sleeve part 75 and opening 23.

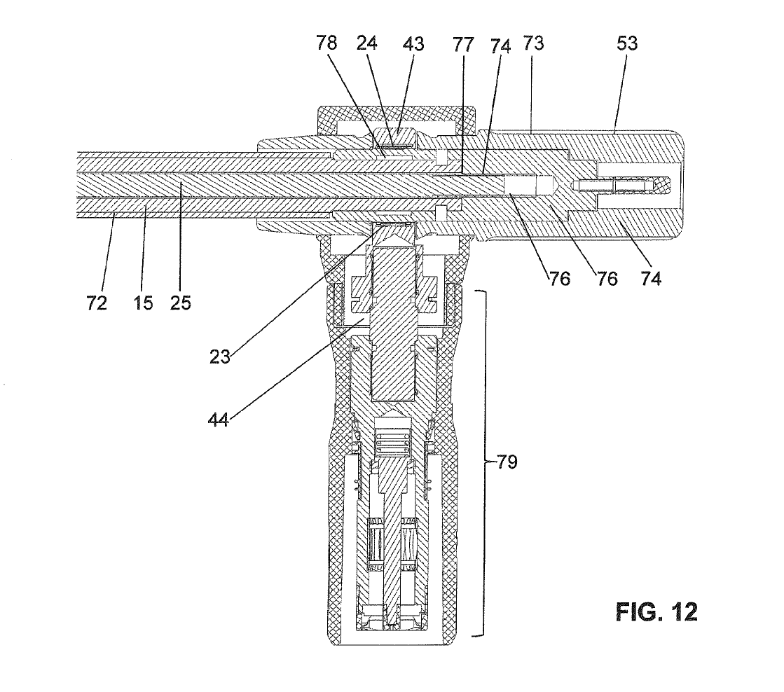

The terminal unit 21 can be formed in a variety of ways. It is particularly preferably formed in accordance with the first embodiment and comprises a terminal portion 44. The terminal portion 44 can be electrically connected to a cable or an adapter part 79, as shown in FIG. 12.

A contact device 1 for contacting a bus bar in accordance with a third embodiment is shown in FIGS. 13a to 18. Like parts carry like reference signs compared with the previous figures. The third embodiment differs from the first embodiment fundamentally by the design of the clamping unit 5, in particular of the clamping element 11, and by the design of the contact unit 6, in particular of the contact element 11, and by the design of the parts responsible for the movement between clamping unit 5 and the contact unit 6.

The contact element 11 could also be used, however, in the other embodiments.

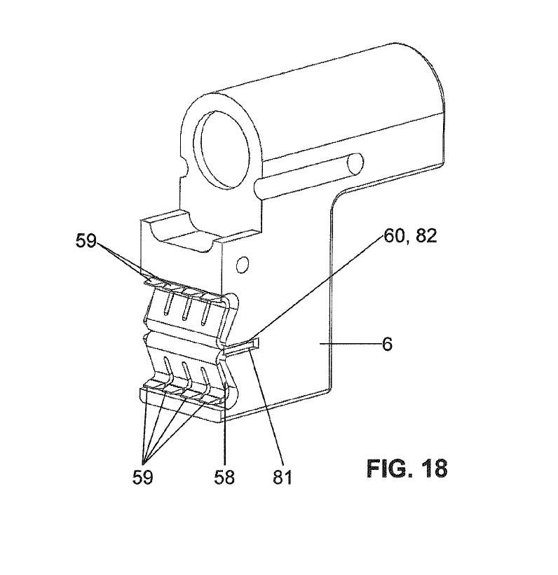

The contact element 11, which can be clearly seen in FIG. 18, here has the form of at least one claw 58 with claw portions 59 protruding into the intermediate space, which claw 58 is mounted in a claw mount 60 in the contact jaw 9. The claw portions 59 comprise said contact face 34 for electrically contacting the bus bar 2.

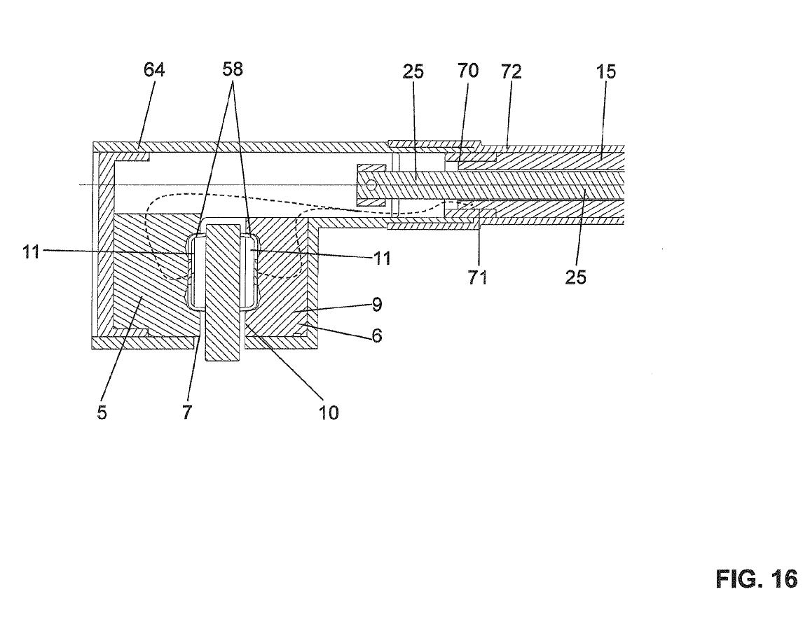

It can be clearly seen from the partially sectional illustration in FIG. 13b and in the sectional illustration according to FIG. 13c that in the third embodiment not only is electrical contact between the contact jaw 9 and the pipe 62 provided, but electrical contact between the pipe 62 and the clamping jaw 63 is also provided. The clamping jaw 63 is electrically conductively connected to a connection part 69. Here, the connection part 69 is electrically conductively connected to the pipe 62. The connection part 69 is also electrically contacted with the contact jaw 9 and/or the clamping jaw 63 via the conveying element 65. Here, the connection to the clamping jaw 63 is shown in particular, whereas the contact jaw 9 is formed integrally with the connection part 69. Here, the conveying element 65 is installed flat in a plane. The flat installation additionally ensures that the contact jaw 9 and the clamping jaw 63 are non-rotatable relative to one another. The clamping jaw 63 can be displaced with the connection part 69 relative to the conveying element 65. Generally speaking, the clamping element 8 is electrically conductively connected to the contact jaw 9 and to said terminal element 12, here in the form of the pipe 62. In FIGS. 13b and 16 the contact paths between the individual elements are illustrated by dashed lines.

The clamping jaw 63 can be displaced relative to the connection part 69. For this purpose the clamping jaw 63 is fixedly connected to the actuator element 25 via the front end 26 of the actuator element 25. If the fine adjustment described herein is also used, the contact jaw 9 and the conveying element can thus also be displaced relative to the clamping jaw.

Flat guide regions 61 are additionally provided by the flat installation of the conveying element 65. Guide regions 61 of the connection part 69 of this type are shown in FIG. 13b.

In the variant according to FIG. 18 the claw portions 59 on the one hand and a fastening portion 81 on the other hand, which protrudes into a slot 82 in the contact jaw 9, extend from a base portion 80. The slot 82 constitutes the claw mount 60. Here, two such contact elements 11 of this type are arranged, of which the fastening portions 81 protrude into the same slot.

The clamping element 8 also comprises at least one claw mount 60 with a claw 58 mounted therein. The claw 58 in the region of the clamping element 8 can be formed here identically to that in the contact jaw 9.

In the embodiment shown in FIG. 16 the pipe 62 is extended by a bore 71 in the contact jaw 8. The pipe 62 is electrically conductively connected to the contact jaw 8 in this bore 71. In another variant, however, the connection part 69 may also protrude into the pipe 62.

The pipe 62 is surrounded externally by an electrically insulating housing 72.

The clamping element 8 is displaceable relative to the pipe 62 along the center axis M of the pipe 62. The clamping element 8 is preferably mounted movably in a housing 64. The housing 64 is preferably fixedly connected to the housing 72, which surrounds the pipe 62 externally.

A drive element 73 is arranged opposite the clamping unit 5 and the contact unit 6. The contact device thus also comprises a drive element 73. The drive element 73 of the third embodiment is formed slightly differently from the drive element of the second embodiment. The drive element 73 in accordance with the third embodiment basically comprises a rough adjustment element 83, by means of which a rough adjustment is made possible between the clamping unit and the contact unit, and a fine adjustment element 84, by means of which a fine adjustment is made possible between the clamping unit and the contact unit.

The rough adjustment element 83 externally has a grip portion 53. The drive element 73 is connected via a thread 76, 77 to the actuator elements 25. In the event of a rotation of the drive element 73, the actuator element 75 is displaced along the center axis of said pipe 62 on account of the cooperation via the thread and the non-rotatable mounting in the pipe 62.

The drive element 73 here comprises a grip part 74 and a sleeve element 75 located non-rotatably in the grip part 74, which sleeve element has an inner thread 76, which is in contact with the outer thread 77 of the actuator element 25. The outer thread 77 is not fully peripheral here.

A sleeve 87 is also electrically conductively contacted with the pipe 62. For this purpose a conveying element is located between the pipe and sleeve part. The sleeve part externally is electrically contacted via a conveying element 24 with the terminal unit 21, more specifically with an opening 23 provided in the terminal receptacle 43. A conveying element 24 producing the electrical contact is preferably arranged between the sleeve part 75 and opening 23.

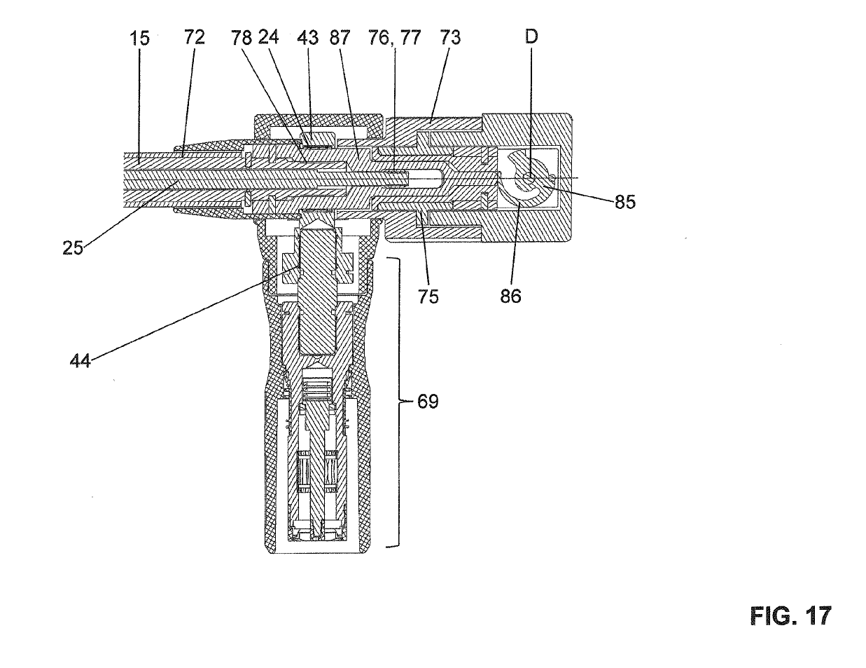

The fine adjustment element is shown clearly in FIGS. 13b and 17. The fine adjustment element 84 in the present embodiment comprises a cam disk 85, in particular with a sprung cam arm 86. The cam disk 85 acts on the rear end of a sleeve 87, which is connected to the pipe 62. The pipe 62 is thus displaced relative to the actuator element 25, such that the contact unit is moved against the clamping unit 5. A fine adjustment can thus be achieved.

The cam disk 85 can be actuated via a drive piece 88. The drive piece 88 is accessible from the outside.

In the particularly preferred embodiment the cam disk 85 is formed such that it can be actuated in the event of the fine adjustment as far as a stop. The cam disk 85 rotates about a rotation axis D, which is at right angles to the movement axis B.

The terminal unit 21 for the third embodiment can be formed in a variety of ways. It is particularly preferably formed in accordance with the first embodiment and comprises a terminal portion 44. The terminal portion 44 can be electrically connected to a cable or an adapter part 79, as shown in FIG. 12.

List of reference signs

| | |
|---|---|
| 1 | contact device |
| 2 | bus bar |
| 3 | contact face |
| 4 | contact face |
| 5 | clamping unit |
| 6 | contact unit |
| 7 | intermediate space |
| 8 | clamping element, |
| | lever |
| 9 | contact jaw |
| 10 | surface |
| 11 | contact element |
| 12 | terminal element |
| 13 | guide element, guide |
| | pin |
| 14 | upper lever portion |
| 15 | connection element, |
| | pipe |
| 16 | bearing point |
| 17 | locking element |
| 18 | groove |
| 19 | opening |
| 20 | conveying element |
| 21 | terminal unit |
| 23 | opening |
| 24 | conveying element |
| 25 | actuator element |
| 26 | front end |
| 27 | inner thread |
| 28 | set screw |
| 29 | rear end |
| 30 | return element |
| 31 | rounded portion |
| 32 | housing |
| 33 | pin |
| 34 | contact face |
| 35 | bore |
| 36 | spring |
| 37 | end region |
| 38 | outer |
| | circumferential face |
| 39 | pivot axis |
| 40 | cutting element |
| 41 | conveying element |
| 42 | openings |
| 43 | terminal receptacle |
| 44 | terminal portion, |
| | contact opening |
| 45 | lower lever portion |
| 46 | bearing element |
| 47 | connection points |
| 48 | first housing part |
| 49 | second housing part |
| 50 | screws |
| 51 | outer thread |
| 52 | inner thread |
| 53 | grip portion |
| 54 | protective shield |
| 55 | housing |
| 56 | rocker |
| 57 | rocker mount |
| 58 | claw |
| 59 | claw portions |
| 60 | claw mount |
| 61 | guide regions |
| 62 | pipe |
| 63 | clamping jaw |
| 64 | housing |
| 65 | conveying element |
| 66 | bearing portion |
| 67 | receiving opening |
| 68 | contact face |
| 69 | connection part |
| 70 | conveying element |
| 71 | bore |
| 72 | housing |
| 73 | drive element |
| 74 | grip part |
| 75 | sleeve element |
| 76 | inner thread |
| 77 | outer thread |
| 78 | conveying element |
| 79 | adapter part |
| 80 | base portion |
| 81 | fastening portion |
| 82 | slot |
| 83 | rough adjustment |
| | element |
| 84 | fine adjustment |
| | element |
| 85 | cam disk |
| 86 | cam arm |
| 87 | sleeve |
| 88 | drive piece |
| 89 | screw connection |
| B | movement axis |
| D | rotation axis |

1. A contact device (1) for contacting a bus bar (2) having at least two contact faces (3, 4) extending parallel to one another and at a distance from one another,
wherein the contact device (1) comprises a clamping unit (5) for applying a clamping force to the first of said contact faces (4) and a contact unit (6) for electrically contacting a second of said contact faces (3),
wherein the clamping unit (5) lies at a distance from the contact unit (6), such that an intermediate space (7) is provided between the clamping unit (5) and the contact unit (6), which intermediate space serves to accommodate said bus bar (2), characterized in that
the clamping unit (5) comprises a clamping element (8) acting on said contact face (4), which clamping element can be moved onto the contact face in relation to the intermediate space (7), and in that
the contact unit (6) comprises a contact jaw (9) having a surface (10) facing toward the intermediate space (7), at least one contact element (11) protruding into the intermediate space (7), and a terminal element (12) electrically conductively connected to the contact element (11).

2. The contact device as claimed in claim 1, characterized in that the contact element (11) comprises a contact face (34), wherein the contact face (34) extends parallel in relation to the surface (10), and/or wherein the contact face comprises at least one cutting element (40) or is provided by the cutting element (40).

3. The contact device as claimed in claim 1 or 2, characterized in that the contact element (11) has the form of a pin (33), which is mounted movably in a bore (35) in the contact jaw (9), wherein the pin (33) comprises said contact face (34) for electrically contacting the bus bar (2), wherein the pin (33) is preferably acted on by a spring (36), which presses the pin (33) in the direction of the surface (10) as considered from the bore, and/or in that the contact face (34) comprises at least one cutting element (40), in particular at least one cutting edge (40) or at least one conical tip.

4. The contact device as claimed in claim 1 or 2, characterized in that the contact element (11) has the form of at least one rocker (56), which is mounted in a rocker mount (57) in the contact jaw (9), wherein the rocker (56) comprises said contact face (34) for electrically contacting the bus bar (2), which rocker (56) where applicable has at least one of said cutting elements (40).

5. The contact device as claimed in claim 1 or 2, characterized in that the contact element (11) has the form of at least one claw (58) having claw portions (59) protruding into the intermediate space, which claw (58) is mounted in a claw mount (60) in the contact jaw (9), wherein the claw portions (59) comprise said contact face (34) for electrically contacting the bus bar (2).

6. The contact device as claimed one of the preceding claims, characterized in that
the clamping element (8) is a lever, or in that
the clamping element (8) is a clamping jaw (63) having a contact face (68), or in that
the clamping element (8) is a clamping jaw (63) having at least one rocker mount (57) and a rocker (56) mounted therein, or in that
the clamping element (8) has a clamping jaw (63) having at least one claw mount (60) and a claw (58) mounted therein.

7. The contact device as claimed in one of the preceding claims, characterized in that the clamping element (8) is electrically conductively connected to the contact jaw (9) and said terminal element (12).

8. The contact device as claimed in one of the preceding claims, characterized in that the clamping unit (5) and the contact unit (6) are displaceable relative to one another along a movement axis (B), such that the width of the intermediate space (7) between clamping unit (5) and contact unit (6) is adjustable.

9. The contact device as claimed in claim 7, characterized in that the contact unit (6) and the clamping unit (5) are in contact via guide elements (13), which allow a relative movement between contact unit (6) and clamping unit (5) along a movement axis (B) and prevent a relative movement about the movement axis (B).

10. The contact device as claimed in claim 9, characterized in that the guide elements (13) have the form of at least one guide pin (13), which protrudes into an opening (42) of the contact unit (6) and an opening of the clamping unit (5), or in that the guide elements (13) are provided by housing parts surrounding the contact unit (6) and the clamping unit (5), or in that the guide elements (13) are provided by flat guide regions (61).

11. The contact device as claimed in one of the preceding claims, characterized in that the contact device has an elongate connection element (15) extending along the movement axis (B), via which connection element the contact unit (6) and the clamping unit (5) are connected to one another, wherein the connection element (15) preferably has the form of a bar or a pipe (15).

12. The contact device as claimed in claim 11, characterized in that the clamping unit (5), preferably in the end region (37) of the connection element (15), is connected to the connection element (15) fixedly in relation to a movement along the movement axis (B), and in that the contact unit (6) is mounted movably on the outer circumferential face (38) of the connection element (15).

13. The contact device as claimed in claim 12, characterized in that the connection element (15) is mounted rotatably about the movement axis (B) relative to the stationary clamping unit (5) and relative to the stationary contact unit (6).

14. The contact device as claimed in one of claims 11 to 12, characterized in that the connection element (15) is connected to the clamping unit (5) via a bearing point (16), wherein the connection element (15) is mounted fixedly relative to the clamping unit (5) in relation to a movement along said movement axis (B), and wherein the connection element (15) is mounted rotatably relative to the clamping unit (5) in relation to a movement about the movement axis (B).

15. The contact device as claimed in one of claims 11 to 14, characterized in that the contact unit (6), in particular the contact jaw (9), has a continuous opening (19), wherein the connection element (15) is guided through this opening (19), wherein the connection element (15) relative to the contact unit (6) is pivotable about the movement axis (B) and is movable along the movement axis (B).

16. The contact device as claimed in one of the preceding claims 11 to 15, characterized in that the radially stationary contact unit (6) is moved along the movement axis (B) via a thread (20, 51) by rotation of the connection element (15), wherein the opening (19) in the contact unit (6) preferably has an inner thread (52) and the connection element (15) has an outer thread (51) cooperating with the inner thread (52), wherein, when the connection element (15) is rotated relative to the stationary contact unit (6), the contact unit (6) is moved along the movement axis (B).

17. The contact device as claimed in one of the preceding claims, characterized in that the connection element (15) is part of the terminal element (12), wherein the connection element (15) is electrically contacted with the contact elements (11) of the contact unit (6) via an electrically conductive connection.

18. The contact device as claimed in one of the preceding claims, characterized in that the at least one contact element (11) is electrically conductively connected to the contact jaw (9), and in that the contact jaw (9) is electrically conductively connected to the connection element (15), wherein a conveying element (20), preferably a multi-lamella contact (20), is preferably provided between the at least one contact element (11) and the contact jaw (9) and/or between the contact jaw (9) and the connection element (15).

19. The contact device as claimed in one of claims 1 to 10, characterized in that the terminal element (12) is a pipe (62), in which an actuator element (25) is mounted longitudinally displaceably along the center axis (M) of the pipe (62) and non-rotatably relative to the pipe (62), which actuator element (25) acts via its front end (26) on the clamping element (8), in particular on the clamping jaw (63), and is particularly preferably connected fixedly thereto, whereby the clamping element (8) is displaceable relative to the contact unit (6).

20. The contact device as claimed in claim 19, characterized in that the clamping element (8) is displaceable relative to the pipe (62) along the center axis (M) thereof, wherein the clamping element (8) is preferably mounted movably in a housing (64), which housing (64) is fixedly connected to the pipe (62).

21. The contact device as claimed in one of claim 19 or 20, characterized in that the actuator element (25) is fixedly connected via its front end (26) to the clamping element (8), in particular to the clamping jaw (63).

22. The contact device as claimed in one of claims 19 to 21, characterized in that the clamping element (8), in particular the clamping jaw (63), is electrically conductively connected to the pipe (62), wherein a conveying element (65, 70), preferably a multi-lamella contact (65, 70), conveying the electrical contact is arranged between the clamping element (7) and the pipe (62),
wherein the conveying element (65) preferably lies inside the pipe (62) or in a bore (71) in the contact jaw (8), said bore extending the pipe (62), the contact jaw being electrically conductively connected to the pipe (62), and wherein a connection part (69), which is electrically conductively connected to the clamping jaw (63), protrudes into the pipe (62) or the bore (71),
or wherein the conveying element (65) preferably extends in a plane.

23. The contact device as claimed in one of claims 19 to 21, characterized in that the contact unit (5), in particular the contact jaw (9), is electrically conductively connected to the pipe (62), preferably via an integrally bonded connection.

24. The contact device as claimed in one of claims 19 to 23, characterized in that the contact device further comprises a drive element (73), which is connected via a thread (76, 77) to the actuator element (25), wherein, in the event of a rotation of the drive element (73), the actuator element (25) is displaced along the center axis of said pipe (62).

25. The contact device as claimed in claim 24, characterized in that the drive element (73) has a grip part (74) and a sleeve element (75) located non-rotatably in the grip part (74), which sleeve has said thread.

26. The contact device as claimed in claim 24 or 25, characterized in that the drive element is a rough adjustment element (83), which enables a rough adjustment between the clamping unit (5) and the contact unit (6), and in that a fine adjustment is possible between the clamping unit (5) and contact unit (6) via a fine adjustment element (84).

27. The contact device as claimed in claim 26, characterized in that the fine adjustment element (84) is a cam disk (85), in particular with a sprung cam arm (86), wherein the cam disk acts on the rear end of a sleeve (87), which is in contact with the pipe (62), whereby the pipe (62) is displaced relative to the actuator element (25), such that the contact unit (6) is moved against the clamping unit (5).

28. The contact device as claimed in one of the preceding claims, characterized in that the terminal element (12), in particular the pipe, protrudes into a terminal unit (21) and is in direct or indirect electrically conductive contact there with a terminal receptacle (43) and has a terminal portion (44) for receiving a cable.

29. The contact device as claimed in claim 28, characterized in that the connection element (15) or the terminal element (12), in particular the pipe (62), extends at least partially into an opening (23) in the terminal receptacle (43), wherein a conveying element (24), in particular a multi-lamella contact, is arranged in the opening (23) and conveys electrical contact between the terminal receptacle (21) and connection element (15) or the terminal element (12), in particular the pipe (62), and wherein the connection element (15) or the terminal element (12), in particular the pipe (62), is mounted rotatably or fixedly in the opening (23).

30. The contact device as claimed in one of the preceding claims, characterized in that the clamping element (8) can be actuated using an actuator element (25), wherein the actuator element (25) is preferably a rod (25) mounted through the connection element (15), which rod acts via a front end (26) on the clamping element (8), in particular the lever.

31. The contact device as claimed in claim 30, characterized in that the connection element (15) has an inner thread (27) for receiving a set screw (28), wherein the set screw (28) acts on the actuator element (25), in particular on the rear end (29) of the rod, and, in the event of a rotation of the set screw (28), the actuator element (25) is moved in the connection element (15).

32. The contact device as claimed in one of the preceding claims, characterized in that the lever (8) has a return element (30) in the form of a spring, which holds the lever (8) in a rest position, and/or in that the lever (8) is elbowed and has a rounded portion (31) in the region of the point of contact with the bus bar, and/or in that the contact device also has a housing (32), which is electrically insulating, wherein the housing (32) preferably comprises a first housing part and a second housing part, which first housing part (48) extends around the contact jaw (9), and which second housing part (49) extends around the connection element (15) and is connected thereto for conjoint rotation therewith, wherein the housing parts overlap one another in portions.
